(19) United States
(12) Patent Application Publication
(10) Pub. No.: US 2016/0160001 A1
(43) Pub. Date: Jun. 9, 2016

(54) ULTRAHIGH LOADING OF CARBON NANOTUBES IN STRUCTURAL RESINS

(71) Applicant: Northrop Grumman Systems Corporation, Falls Church, VA (US)

(72) Inventors: Edward M. Silverman, Encino, CA (US); Hsiao-Hu Peng, Rancho Palos Verdes, CA (US)

(21) Appl. No.: 14/534,464

(22) Filed: Nov. 6, 2014

(51) Int. Cl. C08K 3/04

(52) U.S. Cl. CPC C08K 3/04

(57) ABSTRACT

A polymer composite material that achieves an improved damage resistant performance reinforced composite by adding carbon nanotubes (CNTs) is disclosed. The CNTs serve as the mechanical strengthening component. Higher filler loadings and filler surface area proved by CNTs result in volume maximization which provides a more homogeneous distribution of fillers. This allows the formation of a network of nanofibers which reduces the filler-free volume of the matrix, effectively filling nano-sized voids.

### GOVERNMENT CONTRACT

The Government of the United States of America has rights in this invention pursuant to Government Contract No. 08-C-0297.

### FIELD OF THE INVENTION

The invention relates generally to polymer composites and more particularly to improved composites incorporating nano fillers.

### BACKGROUND

Carbon fiber-reinforced polymers (CFRPs) are used for a wide range of engineering applications requiring high strength-to-weight ratio and rigidity, from aerospace and automotive applications to sporting goods, for example. Often, other fibers and materials are added to the polymer to fine tune the properties of the material, such as flexibility and heat-resistance. In particular, carbon nanotubes (CNTs) have unique properties that make them promising reinforcements for many engineering materials. There has been ongoing interest in forming composite materials from polymers and CNTs that have mechanical, thermal and electrical improvements.

Conventional CFRP composites include low strain-to-failure and low aspect ratio fiber filaments having a diameter of as least 5 microns. The low strain-to-failure characteristic of the fibers tends to limit the extension capability of the composites under load and thus, limit the overall toughness of the composites. The low aspect ratio characteristic limits the capability of the composite to form a homogenous network of fibers by restraining the flow of the individual fibers within the polymer, thus causing fiber and resin-rich areas. Also, voids are present in the composite material due to air entrapment caused by the non-uniform structure of the fiber reinforcements. All of these limitations increase the opportunities for premature failure within a fiber reinforced composite. The prior art additions of typically less than 10 wt % CNTs to polymers containing conventional CFRPs have not remedied these performance challenges.

Thus, a need exists for an improved damage resistant reinforced polymer composite.

### SUMMARY

In a first aspect, the invention encompasses a material that achieves an improved damage resistant reinforced composite by adding carbon nanotube fibers, which will serve as the mechanical strengthening component. This approach takes advantage of the higher strain-to-failure and higher aspect ratio properties of carbon nanotube in comparison to conventional carbon fibers.

### DESCRIPTION OF THE DRAWINGS

Features of example implementations of the invention will become apparent from the description, the claims, and the accompanying drawings in which:

FIG. 1A shows a strut-stop part manufactured using a material of the present invention.

FIG. 1B shows illustrates a computer-aided tomography (CT) scanning image of a manufactured part using a prior art material.

FIG. 1C shows a CT scanning image of a manufactured part using a material according to the present invention.

FIG. 1D shows a scanning electron micrograph (SEM) image of a prior art carbon fiber and polymer composite material at 2.5 magnification.

FIG. 1E shows an SEM image of a prior art carbon fiber and polymer composite material at 10.0 magnification.

FIG. 1F shows an SEM image of a CNT/PEEK material according to the present invention at 2.5 magnification.

FIG. 1G shows an SEM image of a CNT/PEEK material according to the present invention at 10.0 magnification.

FIG. 2 is a graph showing the uniform load displacement behavior of several composite materials.

FIG. 3 is a graph showing displacement for a given load for several composite materials.

### DETAILED DESCRIPTION

The invention encompasses reducing the damage prone characteristics of conventional carbon fiber polymer composites by minimizing the occurrence of voids that provide potential fracture sites at the fiber-matrix interphase boundary, and by maximizing the frequency of a toughening mechanisms e.g., reinforcement pull out from the matrix, the number of reinforcements and increasing the surface area to volume ratio of the reinforcements.

In an embodiment, the invention replaces conventional low aspect ratio carbon fibers in a polymer resin, for example, polyether ether ketone (PEEK), with sufficiently high loading of high strain-to-failure, large aspect ratio nanofilaments. This provides the benefits of multiple mechanical reinforcement of the polymer resin at the nano level and enhanced toughness through the provision of a more homogenous and isotropic distribution of the reinforcements that will result in a void-free composite. In addition, a maximized filament count and increased filament-resin surfaces for filament pull-out enhance the toughening mechanisms of fiber fracture and fiber-matrix pull out.

Nano fillers such as CNTs are characterized by their higher aspect ratio in comparison to conventional carbon fibers. For example, a typical individual carbon fiber had an average diameter on the order of 5 micronmeters or 5000 nanometers and an average length of approximately 1 millimeter, resulting in an aspect ratio (defined as the length divided by the diameter) of around 200. In contrast, the average diameter of a typical individual CNT is approximately 20 to 35 nanometers with a length of approximately 0.01-0.1 millimeters resulting in an average aspect ratio between 300 and 5000. As a result, the higher aspect ratio CNT arrays are unique because their small size and high aspect ratio allow them to form a network of very high area distribution density (>1600 μm−2). Enhanced toughness requires maximizing the mechanisms of fiber-matrix pull-out and fiber fracture, which are achieved with higher filler loadings and filler surface area to volume maximization. In addition, the network of nanofibers will allow the formation of a homogeneous distribution of fillers which reduces the filler-free volume of the matrix, and effectively filling nano-sized voids. As a result, micro-cracks are interrupted much more quickly and frequently during propagation in a nanoreinforced matrix; producing much lower crack widths at the point of first contact between the moving crack front and the CNT. In general, CNTs can provide a very high surface area to volume (SA/V) ratio, which is one of the most important and desired elements in fiber-reinforced composite systems in order to obtain the best and the most efficient composite materials. A higher SA/V ratio means a larger contact area between the fibers and the surrounding matrix, hence higher interaction with the matrix and more efficient reinforcing.

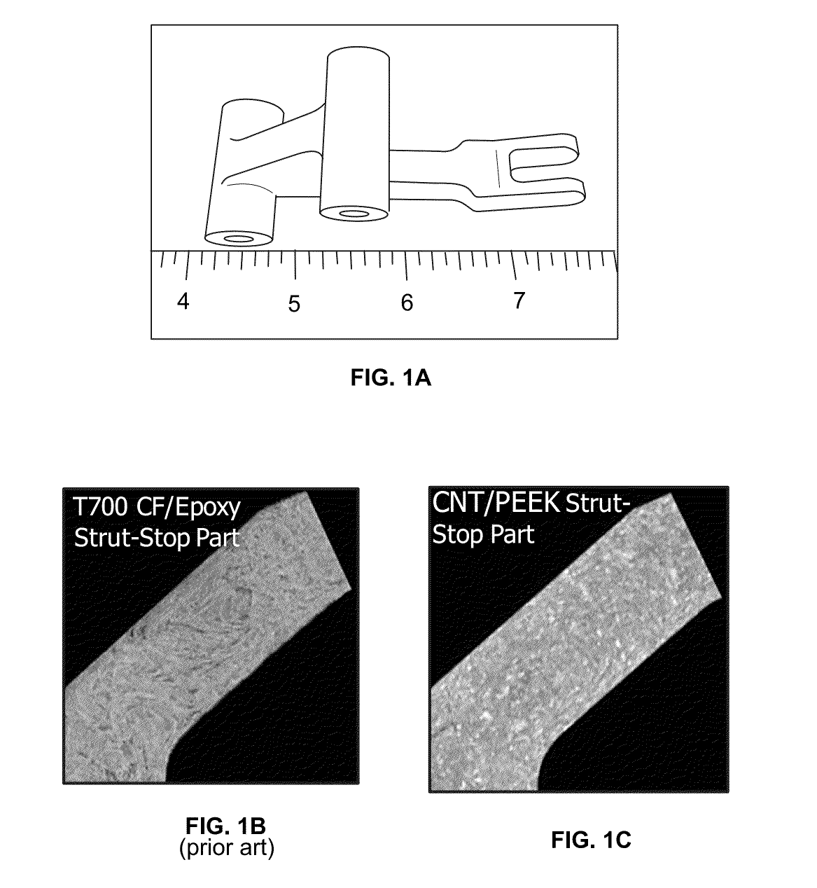

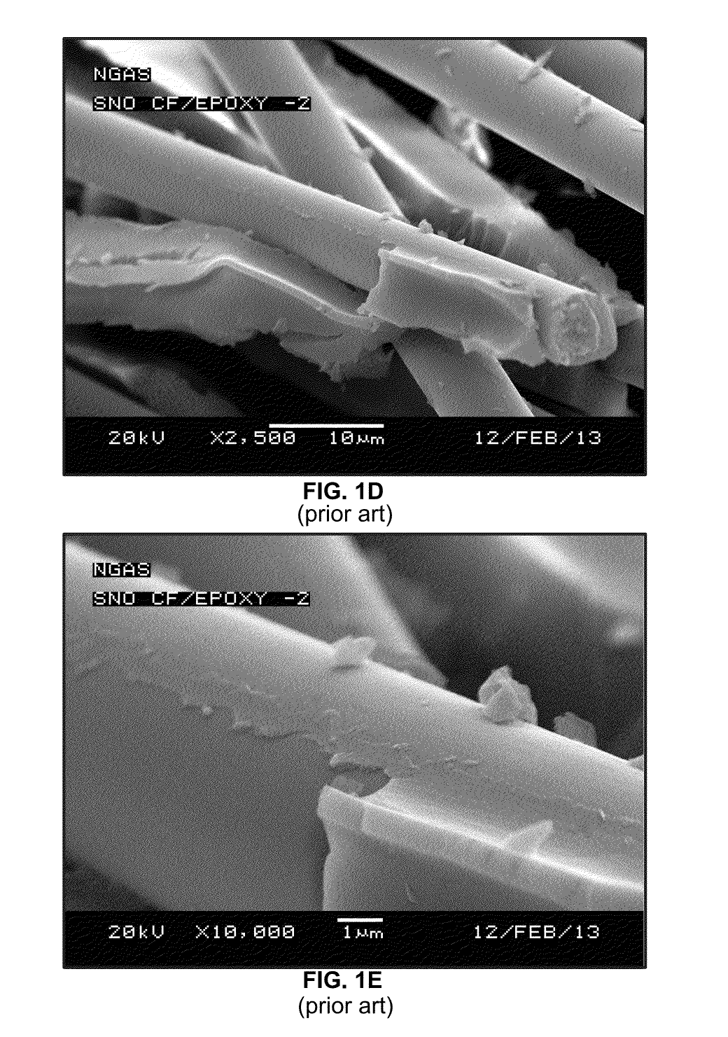

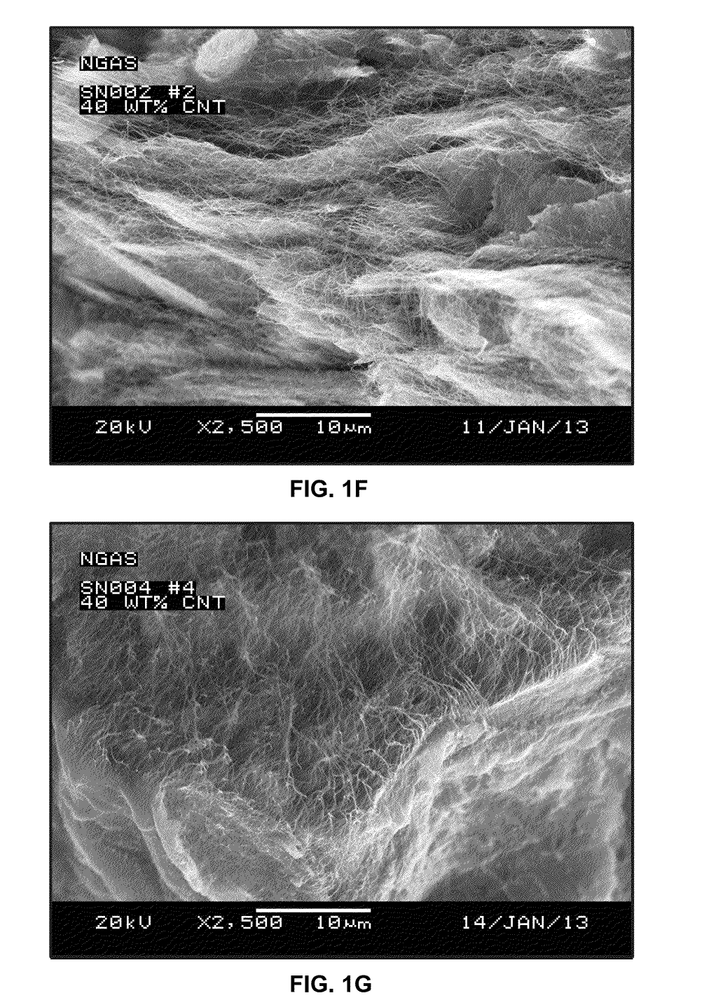

FIG. 1A illustrates a strut-stop part manufactured using a CNT/PEEK composite material according to the invention. Although a specific part is shown, one of ordinary skill in the art would recognize that any simple or complex part could be manufactured.

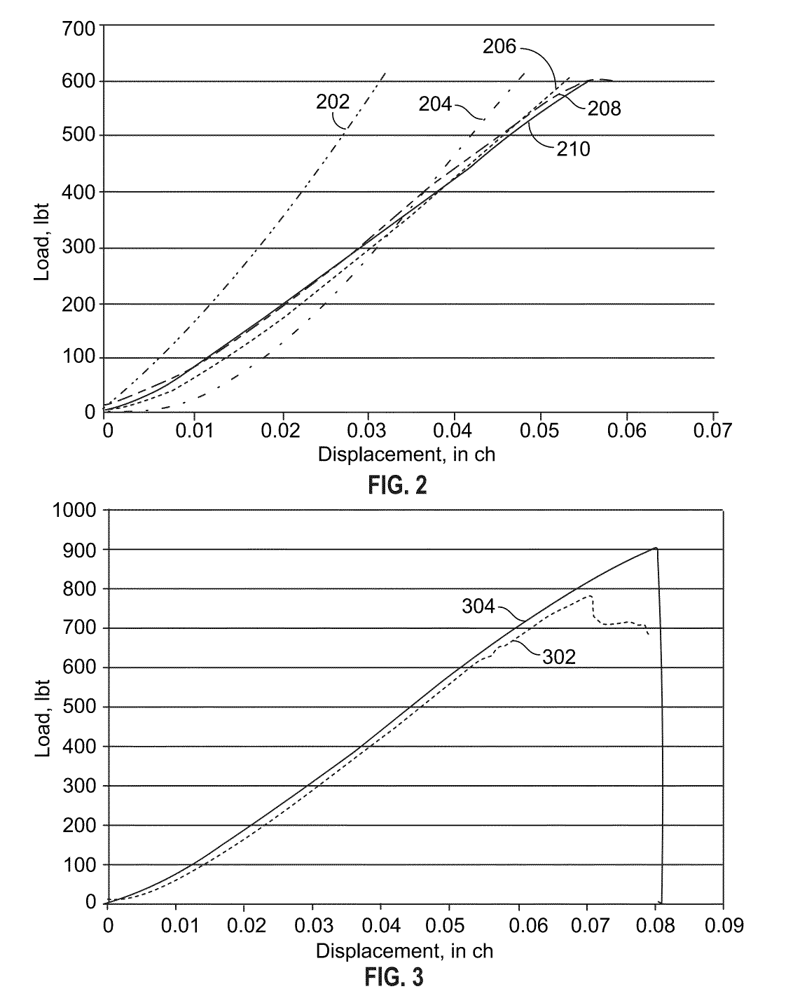

FIG. 1B illustrates a computer-aided tomography (CT) scanning image of a manufactured part using a prior art material of carbon fibers (CF) in epoxy. FIG. 1C illustrates a CT scanning image of a manufactured part using a CNT/PEEK material according to the present invention. It is apparent from a comparison of the figures that the material of FIG. 1B is less homogeneous and more anisotropic than the inventive material, shown in FIG. 1C. The material of FIG. 1C also has a more reproducible load-displacement behavior, discussed in connection FIG. 2.

The uniformity of the CNTs within the PEEK matrix resin in comparison to the conventional carbon fibers within the epoxy matrix resin is readily observed in scanning electron micrographs (SEMs) images, shown in FIGS. 1D-G. Conventional carbon fibers in a PEEK matris resin are shown in FIG. 1D at 2.5 magnification and FIG. 1E at 10.0 magnification. A CNT composite material according the present invention is shown in FIG. 1F at 2.5 magnification and FIG. 1G at 10.0 magnification. As shown in the figures, the much larger aspect ratio of the CNTs relative to the carbon fibers results in a relatively better dispersion of filaments within the matrix resin, as shown by a comparison of FIG. 1D with 1F and FIG. 1E with 1G, respectively.

In an embodiment, the inventive material combines CNTs with a PEEK resin, for example, although any polymer resin could be used. The material has between a 5 wt % and a 40 wt % loading of CNTs in the PEEK. In a further embodiment, the inventive composite material includes a polymer resin with carbon fibers, as well as CNTs. Either the carbon fibers or the CNTs can have a loading of up to 40 wt %, but the combined loading of both carbon fibers and CNTs does not exceed 60 wt %.

FIG. 2 is a graph showing the uniform compressive load displacement behavior of several materials. The load, in units of lbf (pounds per square inch of force), in terms of displacement, in inches, is plotted for two separate 57 wt % carbon fiber/epoxy components made of the material shown in FIG. 1B as lines 202 and 204. Lines 206, 208 and 210 of FIG. 2 show the improved test performance of the inventive material of FIG. 1C as three separate CNT/PEEK components. The uniformity of the distribution of the CNTs within the PEEK polymer results in a more stress distribution within the component as representative by the uniform behavior of the compressive behavior from component to component as shown by relative uniformity of lines 206, 208 and 210. In contrast, the large difference between lines 202 and 204 shows that the non-uniformity of the carbon fiber distribution causes variability in the compression behavior between the two components that were tested.

As shown in the FIG. 3 graph, the CNT/PEEK material as depicted by line 304 is capable of withstanding a higher load and also achieves more consistent results than the CF/epoxy material, depicted by line 302. The result that CNT/PEEK can withstand a higher load is unexpected since CNTs alone have lower tensile and compression strength. In contrast, carbon fiber, by itself, has higher tensile and compression strength, and therefore it is stronger than CNT ropes alone. However, the ability of the CNT/PEEK material to withstand a higher load in comparison to the stronger carbon fiber/epoxy material can be attributed to the higher toughness of the CNT/PEEK and its higher toughness mechanisms, e.g., more fiber-resin pullouts, higher surface area to volume ratio of the nanotubes attributed to its more CNTs uniformity and larger aspect ratio.

Typically, failure of a composite material is understood to occur in a number ways, including cracking of the polymer matrix, fiber breakage and fibers pulling out of the polymer matrix. Testing has shown that reinforcing the composite at the nano-level provides a homogeneous network of nanofiber-resin surfaces that minimizes void formation as well as provides additional toughening mechanisms by maximizing the number of nanofiber-resin pull-out events and by maximizing the number of nanofibers. Ultimately, a nanofiber reinforced composite will minimize the opportunities for fracture resulting in a higher strength behavior for a CNT reinforced composite in comparison to a conventional carbon fiber reinforced composite as shown in FIG. 3, even though the carbon nanotube reinforcing bundles have lower strength in comparison to the conventional carbon fibers. As explained above, FIG. 3 is a graph showing displacement for a given load for the 57 wt % CF/Epoxy at line 302 and for the inventive 40 wt % CNT/PEEK material at line 304. The CF Epoxy material starts to break down at about 790 lbf while the CNT/PEEK material of line 304 doesn't fail until at least 900 lbf.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A composite material, comprising a polymer resin and between 5 and 40 wt % carbon nanotubes (CNT).

2. The composite material of claim 1, wherein the polymer resin is polyether ether ketone.

3. The composite material of claim 1, wherein the CNTs comprise greater than 30 wt % of the material.

4. The composite material of claim 1, wherein the CNTs have a diameter of approximately 20 to 35 nanometers and a length of approximately 100 micrometers.

5. The composite material of claim 1, wherein the CNTs have an aspect ratio greater than 2800.

6. The composite material of claim 1, wherein the material does not comprise carbon fibers.

7. The composite material of claim 1, further comprising carbon fibers having diameter of approximately 5000 nm and a length of approximately 1 millimeter.

8. A polymer nanocomposite comprising a polymer resin selected from the group consisting of thermoplastics and between 5 to 40 wt % carbon nanotubes (CNTs) selected from the group consisting of single-walled CNTs (SWCNTs), multi-walled CNTs (MWCNTs) and carbon nano-fibers.

9. The polymer nanocomposite of claim 8, wherein the polymer resin is polyether ether ketone.

10. The composite material of claim 8, wherein the CNTs comprise greater than 30 wt % of the material.

11. The polymer nanocomposite of claim 8, wherein the CNTs have a diameter of approximately 20 to 35 nanometers and a length of approximately 0.01-0.1 millimeters.

12. The polymer nanocomposite of claim 8, wherein the CNTs have an aspect ratio greater than 300.

13. The polymer nanocomposite of claim 8, wherein the material does not comprise carbon fibers.

14. The polymer nanocomposite of claim 8, further comprising carbon fibers having diameter of approximately 5000 nm and a length of approximately 1 millimeter.
